(19) United States
(12) Patent Application Publication
(10) Pub. No.: US 2005/0109963 A1
(43) Pub. Date: May 26, 2005

(54) Computer radiographic scanner having a light emitting diode array and charge coupled detector array

(75) Inventors: Roger S. Kerr, Brockport, NY (US); Seung-Ho Baek, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/718,903

(22) Filed: Nov. 21, 2003

(51) Int. Cl. G01N 23/04

(52) U.S. Cl. 250/586

(57) ABSTRACT

A raster scanning system for scanning photo-stimulable radiographic media (14), comprises a light emitting diode array (10) adapted to fire a beam (11) to form a stimulated area (13) of radiographic media generating emitted light (15). Collection optics (16) adapts to collect emitted light and reflected light (17) from the radiographic media. A filter (18) permits the emitted light to pass to a charge coupled detector (CCD) (20). An analog to digital converter (22) receives the signal from the charge coupled detector. A control processing unit (CPU) (24) receives the converted signal. An output device (26) processes the signal from the control processing unit.

### CROSS REFERENCE TO RELATED APPLICATIONS

Reference is made to commonly-assigned copending U.S. patent application Ser. No. ______(Attorney Docket No. 86155/NAB), filed herewith, entitled COMPUTER RADIOGRAPHIC SCANNER UTILIZING A SCAN BAR, by Kerr et al.; and U.S. Pat. No. ______(Attorney Docket No. 86270/NAB), filed herewith, entitled INTEGRATED SCAN MODULE FOR A COMPUTER RADIOGRAPHY INPUT SCANNING SYSTEM, by Baek et al., the disclosures of which are incorporated herein.

### FIELD OF THE INVENTION

This invention relates in general to radiography and in particular to scanning a computer radiographic phosphor plate having a latent image to generate a digital image file by means of a scanning apparatus having a modulated flying spot scanning beam, light emitting diode array, and charge coupled detector array.

### BACKGROUND OF THE INVENTION

Radiographic media, which can be sheets, plates or combinations of these with latent images disposed on them have been subject to very slow scanning and low quality, when the radiographic media, typically a phosphor plate needs scanning.

The present invention was developed to provide a fast, high quality scanning system using light emitting diode arrays which provide controllable light for scanning radiographic media having latent images.

### SUMMARY OF THE INVENTION

A raster scanning system for scanning photo-stimulable radiographic media, comprises a light emitting diode array adapted to fire a beam to form a stimulated area of radiographic media generating emitted light. Collection optics adapts to collect emitted light and reflected light from the radiographic media. A filter permits the emitted light to pass to a charge coupled detector (CCD). An analog to digital converter receives the signal from the charge coupled detector. A control processing unit receives the converted signal. An output device processes the signal from the control processing unit.

The invention and its objects and advantages will become more apparent in the detailed description of the preferred embodiment presented below.

### BRIEF DESCRIPTION OF THE DRAWINGS

FIG. 1 is a single scan embodiment of the invention.

FIG. 2 is a schematic view of a dual scanning system of the invention with a single source of stimulation.

FIG. 3 is a schematic view of a dual scanning system of the invention with a dual side stimulation of the radiographic media.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

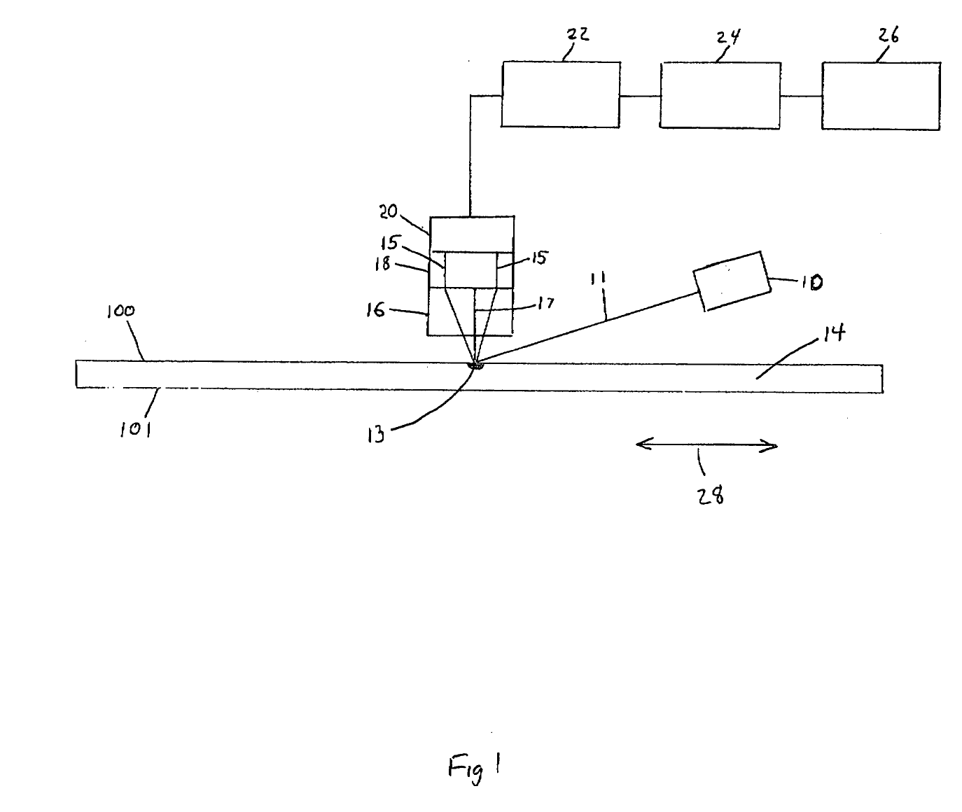

Referring now to FIG. 1 is a system includes a raster scanning system for scanning photo-stimulable radiographic media 14. It uses an light emitting diode light source 10 (referred to hereafter as a light emitting diode array) is adapted to fire a beam 11 to form a stimulated area 13 of radiographic media 14 generating emitted light 15. Collection optics 16 which can be an optical lens system, collects the emitted light 15 and reflected light 17 from the radiographic media.

A blue filter 18 permits the emitted light 15 to pass to a charge coupled detector (CCD) 20. The filter does not permit the reflected light to pass to the CCD. An analog to digital converter 22 receives the signal from the CCD. A control processing unit (CPU) 24 receives the converted signal from the converter 22. An output device 26 is in communication with the CPU for processing the signal. While scanning, the radiographic media 14 moves along axis 28 to allow scanning of larger portions, and up to the entire sheet of radiographic media.

The radiographic media 14 has a first side 100 and a second side 101. The area 13 to be stimulated can be a series of stimulated areas. The radiographic media can be a phosphor sheet. The media is a sheet, a screen, a plate, or combinations thereof.

The light emitting diode array can be very efficient, light emitting element without any optical feedback such as diodes available as model number NSPR346BS or NSPR546BS available from Nichia, of Japan. More than one light emitting diode can be used, such as from 2 to 100 diodes.

The collection optics are preferably a chamber comprising a reflective surface, such as a mirrored surface.

The invention provides a set of collection optics which provide a reflectivity between 80 and 95%.

In a preferred embodiment, the output device is a filmwriter, a printer or a display.

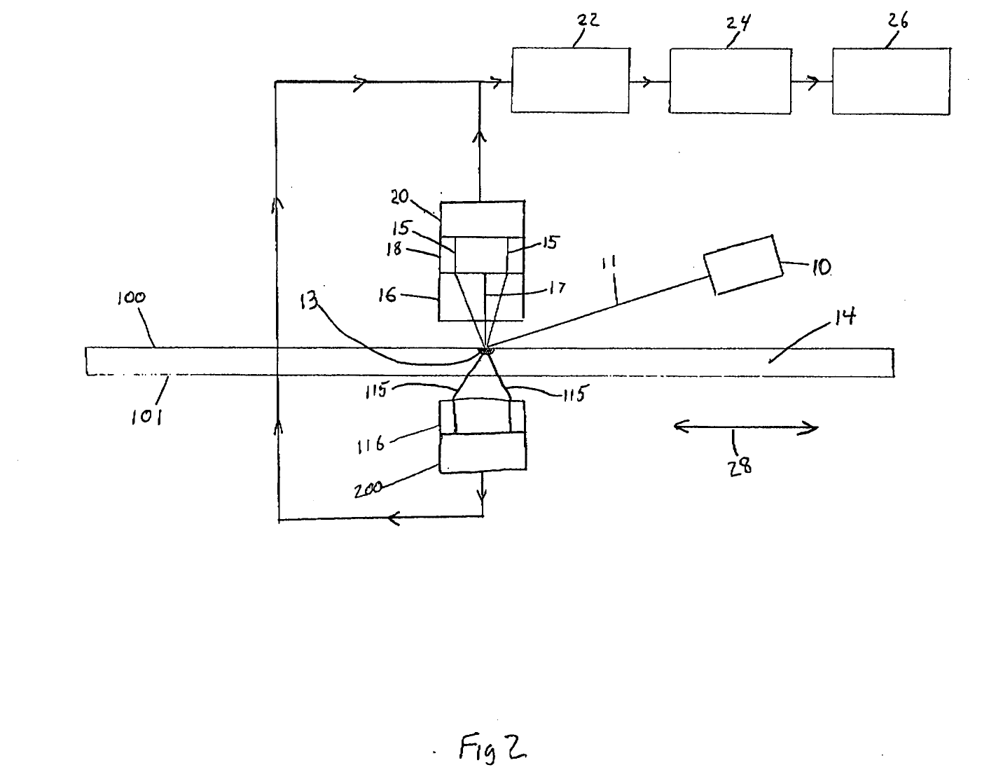

In another embodiment of the invention, as shown in FIG. 2, is a scanning system for scanning photo-stimulable radiographic media from a first side 100 and a second side 101 of the radiographic media 14. It involves a light emitting diode array 10 adapted to fire a beam 11 to stimulate an area 13 of radiographic media 14 generating emitted light 15 and second emitted light 115. The first emitted light 15 and reflected light 17 are collected by the first collection optics 16 and the second emitted light 115 is collected by the second collection optics 116 which is a side of media opposite the first collection optics.

The second collection optics 116 communicates with a second CCD 200 which then generates a second signal and then transmits that second signal to the analog to digital converter 22.

A blue filter 18 permit the emitted light 15 to pass to the first charge coupled detector (CCD) without passing the reflected light 17. The analog to digital converter 22 receives the signals from the first and second CCDs and transmits the signal to a control CPU 24 for receiving and compiling the converted signals. An output device communicates with the CPU for processing the signal from the CPU to a filmwriter or it can be a display.

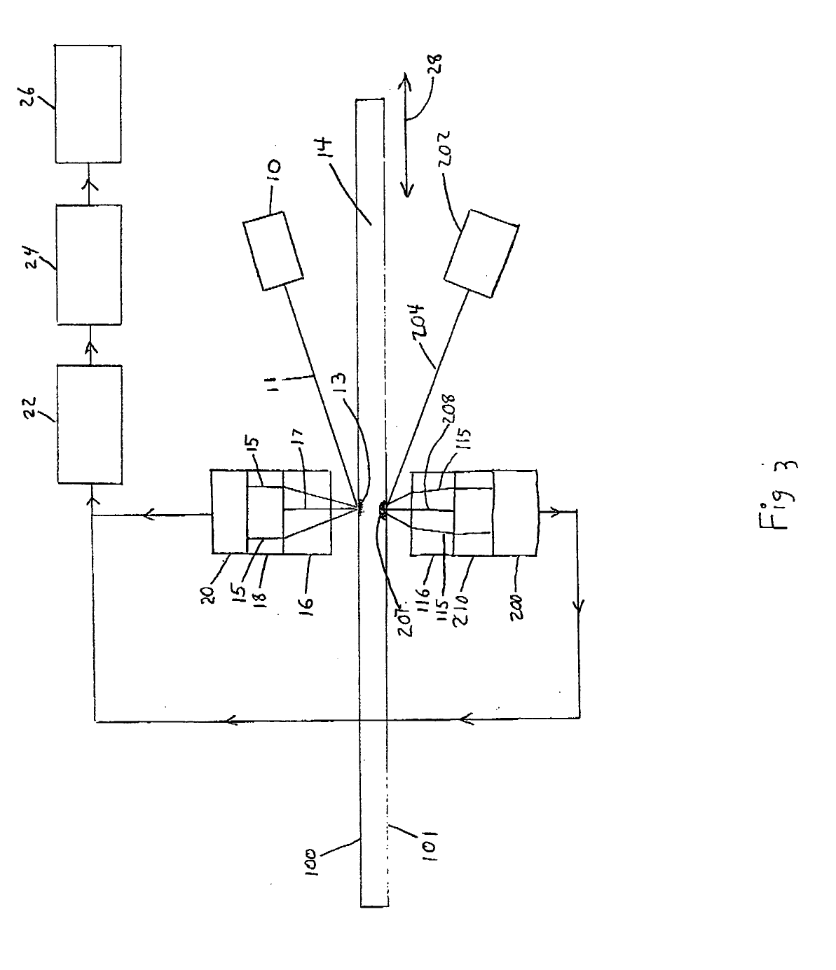

FIG. 3 shows another embodiment of the invention. In this version, radiographic media 14 has a first and second side 100 and 101 respectively. This embodiment has all the elements shown in FIG. 1, but additionally has, on the second side of the radiographic, a second light emitting diode array 202 which provides a second beam 204. This second beam 204 stimulates a second area 207 causing a second emitted light 115 from the radiographic media. Second reflected light 208 is reflected from the surface of the radiographic media and both the second reflected light and the second emitted light are collected by second collection optics 116.

A second filter 210 communicates with the second collection optics to stop the second reflected light from passing to a second CCD 200. Preferably the second filter is a blue filter. Light in the second CCD is converted to a signal which is transmitted to the analog to digital converter 22. The signal is converted to a digital signal and then transmitted to a CPU 24 which compiles the signals and stores the signals. The signals can be transferred to an output device, such as filmwriter 26. It is contemplated that more than one output device can be used in the scope of this invention.

The invention has been described in detail with particular reference to certain preferred embodiments thereof, but it will be understood that variations and modifications can be effected within the scope of the invention.

### PARTS LIST

10 light emitting diode array

11 beam

13 stimulated area

14 radiographic media

15 emitted light from stimulated area

16 first collection optics

17 reflected light

18 filter

20 first charge coupled detector (CCD)

22 analog to digital converter

24 control processing unit (CPU)

26 output device

28 axis

100 first side of radiographic media

101 second side of radiographic media

115 second emitted light

116 second collection optics

200 second charge coupled detector (CCD)

202 second light emitting diode array

204 second beam

207 second stimulated area

208 second reflected light

210 second filter

1. A raster scanning system for scanning photo-stimulable radiographic media, comprising:
(a) light emitting diode array adapted to fire a beam to form a stimulated area of radiographic media generating emitted light;
(b) collection optics adapted to collect emitted light and reflected light from the radiographic media;
(c) a filter to permit the emitted light to pass to a charge coupled detector (CCD);
(d) an analog to digital converter for receiving the signal from the charge coupled detector;
(e) a control processing unit (CPU) for receiving the converted signal; and
(f) an output device for processing the signal from the CPU.

2. The system of claim 1, wherein the area is a series of stimulated areas.

3. The system of claim 1, wherein the radiographic media is a phosphor sheet.

4. The system of claim 1, wherein the radiographic media is a sheet, a screen, a plate, or combinations thereof.

5. The system of claim 1, wherein the collection optics are a chamber comprising a reflective surface.

6. The system of claim 1, wherein the radiographic media moves along an axis perpendicular to the stimulated line.

7. The system of claim 5, wherein the reflective surface is a mirrored surface.

8. The system of claim 1, wherein the collection optics provide a reflectivity between 80 and 95%.

9. The system of claim 1, wherein the filter is blue.

10. The system of claim 1, wherein the collection optics has a collection efficiency of approximately 52%.

11. The system of claim 1, wherein the output device is a filmwriter, a printer or a display.

12. A raster scanning system for scanning photo-stimulable radiographic media, comprising:
(a) light emitting diode array adapted to fire a beam to stimulate an area of radiographic media which generates emitted light, wherein said radiographic media has a first side and a second side;
(b) a first collection optics to collect emitted light and reflected light from the radiographic media disposed on a first side of the radiographic media and a second collection optics to collect second emitted light disposed on a second side of the radiographic media;
(c) a filter to permit the emitted light to pass to a first charge coupled detector (CCD);
(d) a second charge coupled detector disposed on the second side to and in communication with the second collection optics;
(e) an analog to digital converter for receiving the signals from the first and second CCDs;
(f) a control processing unit for receiving and compiling the signal from the analog to digital converter; and
(g) an output device for processing the signal from the control process unit.

13. The system of claim 12, wherein the area is a series of stimulated areas.

14. The system of claim 12, wherein the radiographic media is a phosphor sheet.

15. The system of claim 12, wherein the radiographic media is a sheet, a screen, a plate, or combinations thereof.

16. The system of claim 12, wherein the first and second collection optics are each a chamber comprising a reflective surface.

17. The system of claim 12, wherein the radiographic media moves along an axis perpendicular to the stimulated line.

18. The system of claim 16, wherein the reflective surface is a mirrored surface.

19. The system of claim 12, wherein the collection optics provide a reflectivity between 80 and 95%.

20. The system of claim 16, wherein the filter is blue.

21. The system of claim 16, wherein the collection optics has a collection efficiency of approximately 52%.

22. The system of claim 1, further comprising a second light emitting diode array and second filter disposed on the second side of the radiographic media to stimulate a second area for emitting light.
